(19) United States
(12) Patent Application Publication
(10) Pub. No.: US 2011/0040504 A1
(43) Pub. Date: Feb. 17, 2011

(54) FRUIT MATURITY DETERMINATION METHOD AND SYSTEM

(75) Inventors: TIANTIAN LIU, Harbin (CN); LIN YANG, Harbin (CN); GANG WU, Harbin (CN); WELHONG GU, Harbin (CN)

Correspondence Address: REN-SHENG INTERNATIONAL IP MANAGEMENT LTD.;GENE I. SU, 7F, No. 57, Sec. 2, DunHua South Road, TAIPEI, TW

(73) Assignee: Rong Zhi Xin Science and Technology Development (Beijing) Co., Ltd., Beijing (CN)

(21) Appl. No.: 12/538,885

(22) Filed: Aug. 11, 2009

(51) Int. Cl. G01N 29/46; G01H 13/00

(52) U.S. Cl. 702/56; 73/579; 702/77

(57) ABSTRACT

In accordance with some embodiments of the present disclosure, a method for determining fruit maturity is disclosed. The method includes measuring acceleration data associated with an impulse response signal of a target fruit to an excitation force applied to such a target fruit, computing a frequency response of the impulse response signal based on digitized acceleration data, determining a first order resonance frequency from the frequency response, and non-destructively determining a level of maturity for the target fruit based on one or more physical properties of the target fruit and the first order resonance frequency.

### BACKGROUND

Unless otherwise indicated herein, the approaches described in this section are not prior art to the claims in this application and are not admitted to be prior art by inclusion in this section.

Maturity at harvest is one of the key determinants for the storage-life and quality of a fruit. Fruits picked either too early or too late in the season are likely of shortened storage-life and of inferior flavor quality than fruits picked at the proper maturity level. Traditionally, a farmer relies on his or her own experience to subjectively determine fruit maturity. For example, one traditional approach to determine the maturity of a watermelon is to “touch, pat, press, and smell” such a watermelon. Another approach is to calculate the growth period of a watermelon and compare such information to historical data to determine its maturity. Yet some other approaches involve destroying a watermelon by separating its skin from its flesh and directly examining the sugar content of the flesh.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1 is a simplified block diagram of an example fruit maturity determination device;

FIG. 2 is a flow chart illustrating an example process for non-destructively determining fruit maturity; and

FIG. 3 is a block diagram illustrating a computer program product for non-destructively determining fruit maturity, all arranged in accordance with at least some embodiments of the present disclosure.

### SUMMARY

In accordance with one embodiment of the present disclosure, a fruit maturity determination device includes an actuator configured to apply an excitation force to a target fruit, an accelerometer configured to measure acceleration data associated with a response signal to the excitation force, and a processing unit configured to determine a first order resonance frequency based on the response signal and non-destructively determine a level of maturity for the target fruit based on one or more physical properties of the target fruit and the first order resonance frequency.

In accordance with another embodiment of the present disclosure, a method for determining fruit maturity includes measuring acceleration data associated with an impulse response signal of a target fruit to an excitation force applied to such a target fruit, computing a frequency response of the impulse response signal based on digitized acceleration data, determining a first order resonance frequency from the frequency response, and non-destructively determining a level of maturity for the target fruit based on one or more physical properties of the target fruit and the first order resonance frequency.

In accordance with yet another embodiment of the present disclosure, a computer readable medium containing a sequence of instructions for determining fruit maturity, which when executed by a computing device, causes the computing device to measure acceleration data associated with an impulse response signal of a target fruit to an excitation force applied to such a target fruit, compute a frequency response of the impulse response signal based on digitized acceleration data, determine a first order resonance frequency from the frequency response, and non-destructively determine a level of maturity for the target fruit based on one or more physical properties of the target fruit and the first order resonance frequency.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

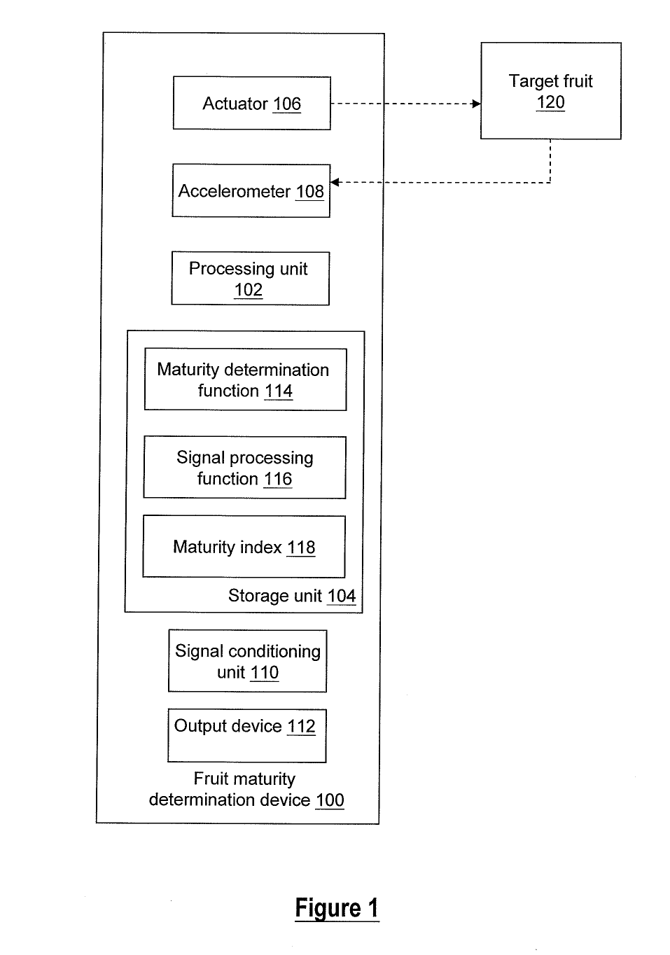

FIG. 1 is a simplified block diagram of an example fruit maturity determination device 100, in accordance with at least some embodiments of the present disclosure. The fruit maturity determination device 100 includes, among other things, a processing unit 102, a storage unit 104, an actuator 106, an accelerometer 108, a signal conditioning unit 110, and an output device 112. In some implementations, the storage unit 104 may store instructions implementing a maturity determination function 114 and a signal processing function 116. The storage unit 104 may also store a maturity index 118, which includes maturity data for one or more species of a target fruit 120.

To determine the level of maturity of the target fruit 120, the processing unit 102 may start by causing the actuator 106 to deliver an impulse excitation force to the target fruit 120. In some implementations, the actuator 106 may be an impulse force hammer, and the target fruit 120 may be a watermelon. By modeling the target fruit 120 as a simplified multi-layer spherical elastomer, this impulse excitation force causes the generation of an impulse response signal, and the vibration frequency of the impulse response signal may correspond to the first order resonance frequency of the elastomer. The accelerometer 108 is configured to measure acceleration it experiences relative to freefall and is here to measure the acceleration information in all three axes (e.g., x, y, and z directions) associated with the impulse response signal.

The signal conditioning unit 110 may be configured to further process the acceleration information outputted by the accelerometer 108. In some implementations, the accelerometer 108 converts the three-axis acceleration information into electrical signals and outputs the acceleration-voltage signals. The signal conditioning unit 110 may feature functions such as signal filtering and signal amplifying to improve the signal-noise-ratio (SNR) of the acceleration-voltage signals. The signal conditioning unit 110 may also include an analog-to-digital converter (ADC), so that the acceleration-voltage signals in the analog domain may be converted into a set of discrete digital samples. The processing unit 102 may be configured to execute instructions for the signal processing function 116, such as a Fast Fourier Transform (FFT) function, to obtain the frequency response for the set of discrete digital samples. With the frequency response, the processing unit 102 may be configured to determine the different orders of resonance frequencies and amplitudes from the frequency response of the impulse response signal. One way to identify the first order resonance frequency is to search for the resonance having the highest amplitude.

In some implementations, when the processing unit 102 executes the instructions for the maturing determination function 118, a numerical value indicative of the level of maturity for the target fruit 120 may be calculated based on the physical properties of the target fruit 120 and also the first order resonance frequency of the impulse response signal. In one example, an elastic modulus (E) of the target fruit 120, which generally refers to the mathematical description of the tendency of the target fruit 120 to be deformed elastically (i.e., non-permanently) when a force is applied to it, may be calculated. One equation for determining the elastic modulus is shown below:

$$E = 4 {ρ𝓁}^{2} {f}^{2} ( \frac{4 + Δ {f}^{2}}{3 {f}^{2}} ) \qquad ( 1 )$$

In equation (1), ρ is the density of the target fruit 120; l vertical size of the target fruit 120; f is the resonance frequency of the target fruit 120; and Δf is the half-power bandwidth of resonance frequency. For a watermelon, the riper the watermelon is, the smaller the elastic modulus of its flesh is. It is important to note that the fruit maturity determination device 100 does not destroy the target fruit 120 (e.g., leaving the skin of the target fruit intact) during the process of calculating the elastic modulus.

In some implementations, the processing unit 102 may be configured to compare the calculated elastic modulus for the target fruit 120 with the data in the maturity index 118. As mentioned above, the maturity index 118 may include maturity data for one or more species of the target fruit 120, and the maturity data may be estimated and compiled through experiments prior to using the fruit maturity determination device 100. By utilizing the relationships among the first order resonance frequency, physical properties, and sugar content of the target fruit 120 (e.g., the higher resonance frequency, the lower the sugar content; and the greater the mass, the lower of the sugar content under the same resonance frequency), a numerical value indicating maturity for a certain target fruit 120 may first be estimated and then confirmed by subsequent physical measurements. Although the maturity index 118 is illustrated to be stored in the storage unit 104, the maturity index 118 may be stored in any storage area, even external to the fruit maturity determination device 100, as long as the storage area is accessible by the fruit maturity determination device 100.

Once compared against the maturity index 118, the fruit maturity determination device 100 may be able to determine whether the target fruit 120 is sufficiently ripened to be harvested. In some implementations, the processing unit 102 may be configured to output the maturity information through the output device 112, so that the maturity information can be reviewed while the fruit determination device 100 is being used on the field. One example output device 112 may be a speaker. Another example output device 112 may be a display device. Yet another example output device 112 may be a combination of the speaker and the display device.

In some implementations, the fruit maturity determination device 100 may include an input device (not shown in FIG. 1), which is configured to receive information such as, without limitation, the species information and the mass information of the target fruit 120. Based on the received information, the fruit maturity determination device 100 may be able to further customize its operations to generate the maturity information. For example, the excitation force applied to the target fruit 120 may differ based on the received species information, and the maturity information looked in the maturity index 118 may also differ based on the received mass information.

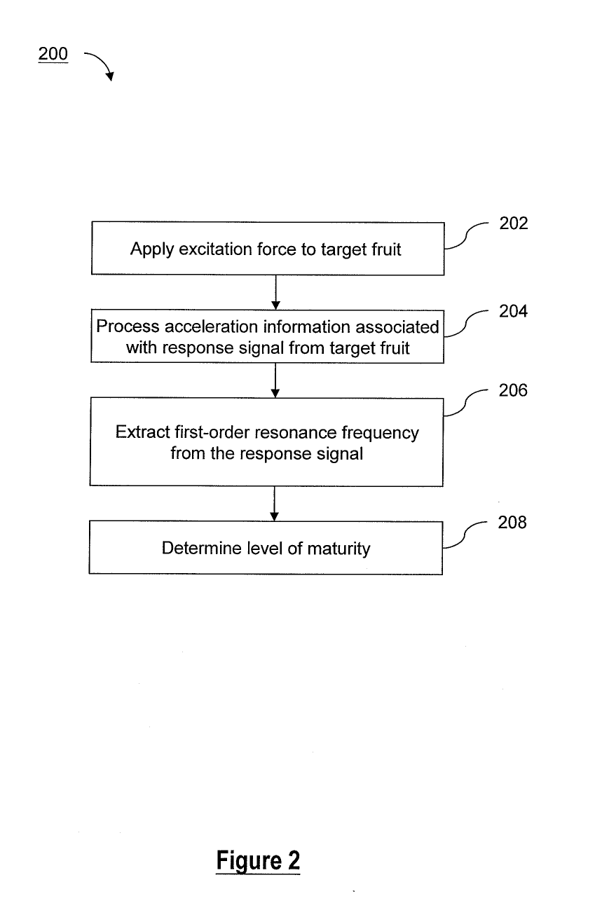

FIG. 2 is a flow chart illustrating an example process 200 for non-destructively determining fruit maturity, in accordance with at least some embodiments of the present disclosure. The example process 200 may begin at operation 202, where an excitation force may be applied to a target fruit. Continuing to operation 204, in response to the excitation force, an impulse response signal may be generated, and the acceleration information associated with such an impulse response signal may be measured and processed. Processing may continue at operation 206, where the first order resonance frequency for the target fruit may be identified. Continuing to operation 208, with the physical properties of the target fruit and the resonance frequency, the level of maturity for the target fruit may be determined. The determined maturity level may also be further compared against a maturity index and outputted.

The excitation force applied in operation 202 may cause a forced vibration response for the target fruit. In some implementations, the forced vibration response may be characterized as m∇²x+c∇x+kx=F, wherein x is the displacement of the target fruit in response to the excitation force F, and m, c, and k are factors, such as density, geometry, or elastic modulus, of the target fruit.

In operation 206, to locate the first order resonance frequency, in some implementations, the acceleration information associated with the impulse response signal obtained in operation 204 may be first converted to a set of discrete digital samples, and then a frequency response for the impulse response signal may be computed. By searching for the largest amplitude in the frequency response for the impulse response signal, the first order resonance frequency may be identified. In operation 208, the level of maturity for the target fruit, as discussed above, may be computed based on the physical properties, such as the mass, and the first order resonance frequency of the target fruit. This computed level of maturity may be further compared against a maturity index, compiled for one or more species of the target fruit, to generate an output indicating whether the target fruit may be sufficiently ripened to be harvested.

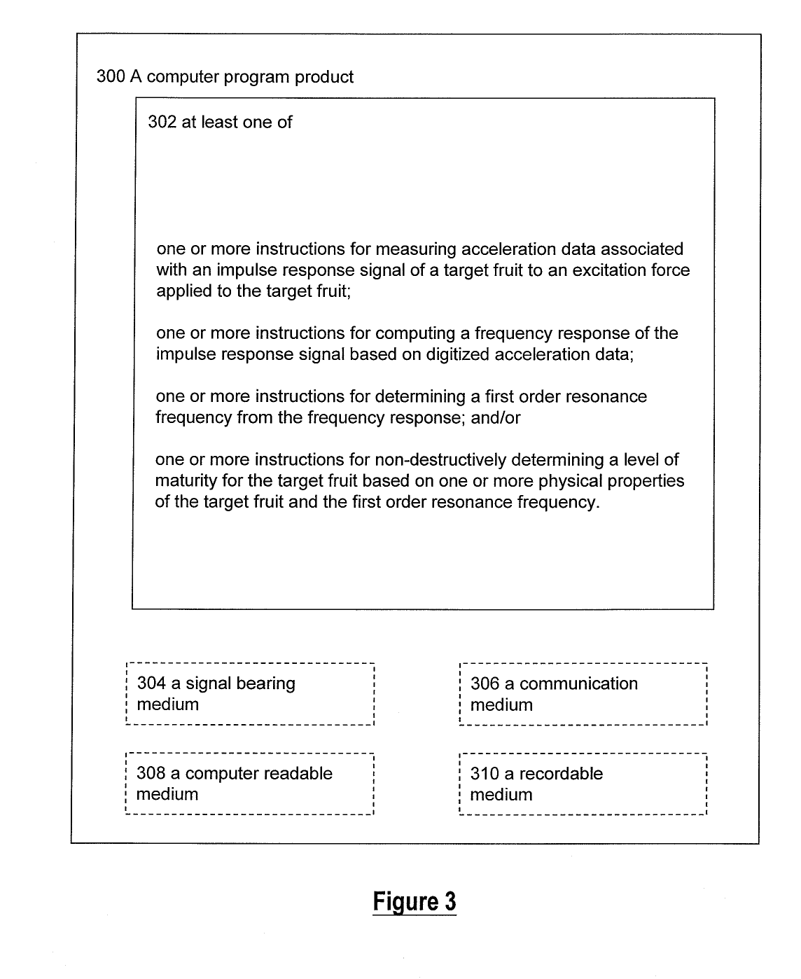

FIG. 3 is a block diagram illustrating a computer program product 300 for non-destructively determining fruit maturity, arranged in accordance with at least some embodiments of the disclosure. Computer program product 300 includes one or more sets of instructions 302, which may reflect the method described above and illustrated in FIG. 2. The computer program product 300 may be transmitted in a signal bearing medium 304 or another similar communication medium 306. Computer program product 300 may be recorded in a computer readable medium 308 or another similar recordable medium 310.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or a firmware configuration; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of the skilled in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact, many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A fruit maturity determination device, comprising:
an actuator configured to apply an excitation force to a target fruit;
an accelerometer configured to measure acceleration data associated with a response signal to the excitation force; and
a processing unit configured to determine a first order resonance frequency based on the response signal and non-destructively determine a level of maturity for the target fruit based on one or more physical properties of the target fruit and the first order resonance frequency.

2. The fruit maturity determination device of claim 1, wherein the one or more physical properties include mass and size of the target fruit.

3. The fruit maturity determination device of claim 1, wherein the processing unit is configured to determine the level of maturity for the target fruit by calculating an elastic modulus of the target fruit.

4. The fruit maturity determination device of claim 1, further comprises:
an analog-to-digital converter configured to convert the response signal in an analog domain to a set of discrete digital samples, wherein the processing unit is configured to perform a fast Fourier transform operation on the set of discrete digital samples to generate a frequency response of the response signal.

5. The fruit maturity determination device of claim 4, wherein the processing unit is configured to extract the first order resonance frequency from the frequency response of the response signal.

6. The fruit maturity determination device of claim 1, wherein the processing unit is configured to compare the level of maturity to a pre-determined maturity index for one or more species of the target fruit.

7. The fruit maturity determination device of claim 1, further comprises an output device configured to output the level of maturity for the target fruit that the processing unit has determined.

8. A method for determining fruit maturity, comprising:
measuring acceleration data associated with an impulse response signal of a target fruit to an excitation force applied to the target fruit;
computing a frequency response of the impulse response signal based on digitized acceleration data;
determining a first order resonance frequency from the frequency response; and
non-destructively determining a level of maturity for the target fruit based on one or more physical properties of the target fruit and the first order resonance frequency.

9. The method of claim 8, wherein the one or more physical properties include mass and size of the target fruit.

10. The method of claim 8, wherein the non-destructively determining a level of maturity further comprises calculating an elastic modulus of the target fruit.

11. The method of claim 8, further comprises comparing the level of maturity to a pre-determined maturity index for one or more species of the target fruit.

12. The method of claim 8, further comprises outputting the level of maturity for the target fruit.

13. The method of claim 8, wherein the non-destructively determining a level of maturity is further based on species information of the target fruit.

14. A computer-readable medium containing a sequence of instructions for determining fruit maturity, which when executed by a computing device, causes the computing device to:
measure acceleration data associated with an impulse response signal of a target fruit to an excitation force applied to the target fruit;
compute a frequency response of the impulse response signal based on digitized acceleration data;
determine a first order resonance frequency from the frequency response; and
non-destructively determine a level of maturity for the target fruit based on one or more physical properties of the target fruit and the first order resonance frequency.

15. The computer-readable medium of claim 14, wherein the one or more physical properties include mass and size of the target fruit.

16. The computer-readable medium of claim 14, further containing a sequence of instructions, which when executed by the computing device, causes the computing device to calculate an elastic modulus of the target fruit.

17. The computer-readable medium of claim 14, further containing a sequence of instructions, which when executed by the computing device, causes the computing device to compare the level of maturity to a pre-determined maturity index for one or more species of the target fruit.

18. The computer-readable medium of claim 14, further containing a sequence of instructions, which when executed by the computing device, causes the computing device to output the level of maturity for the target fruit.

19. The computer-readable medium of claim 14, further containing a sequence of instructions, which when executed by the computing device, causes the computing device to consider species information of the target fruit in determining the level of maturity.
